(19) United States
(12) Patent Application Publication
(10) Pub. No.: US 2009/0051636 A1
(43) Pub. Date: Feb. 26, 2009

(54) Display device

(76) Inventor: Masataka Natori, Chiba (JP)

Correspondence Address: Stanley P. Fisher;Reed Smith LLP, Suite 1400, 3110 Fairview Park Drive, Falls Church, VA, 22042-4503, US

(21) Appl. No.: 12/222,707

(22) Filed: Aug. 14, 2008

(30) Foreign Application Priority Data
Aug. 20, 2007 (JP) 2007-213611

(51) Int. Cl. G09G 3/20

(52) U.S. Cl. 345/87; 345/55

(57) ABSTRACT

The present invention is directed to a display device which can display an image in any region within the display region without affecting the configuration of pixels, even when there is a non-display region. A display device is provided with a number of gate signal lines aligned on a first substrate in one direction and a number of drain signal lines aligned in such a direction as to cross the above described one direction with regions surrounded by these signal lines used as pixels, and characterized in that a non-display region where no gate signal lines, drain signal lines or pixels are formed is provided in part of a display region which is a group of the above described pixels; a number of gate connection wires and a number of drain connection wires are formed so as to be aligned outside the above described display region; a pair of gate signal lines which are divided into two sides of the above described non-display region by the above described non-display region are electrically connected by a corresponding gate connection wire, and a pair of drain signal lines which are divided into two sides of the above described non-display region by the above described non-display region are electrically connected by a corresponding drain connection wire.

The present application claims priority from Japanese Application JP2007-213611 filed on Aug. 20, 2007, the content of which is hereby incorporated by reference into this application.

### BACKGROUND OF THE INVENTION

(1) Field of the Invention

The present invention relates to a display device, and in particular, to an active matrix type display device having a non-display region, for example a window portion, in the display portion.

(2) Related Art Statement

In active matrix type display devices, pixels are formed of at least a thin film transistor which is turned on by a scanning signal from a gate signal line and a pixel electrode to which a video signal is supplied from a drain signal line via the thin film transistor that is turned on in regions surrounded by a number of gate signal lines which extend in the x direction and are aligned in the y direction, and a number of drain signal lines which extend in the y direction and are aligned in the x direction, for example.

As a result, each pixel can be independently controlled, so that a video can be displayed by means of the pixels.

In addition, display devices having such a configuration with a window portion created as a through hole (opening) in a portion of the display region made of a set of the above described pixels so that the rear surface side of the display device, for example, can be viewed with the eye, are known.

Such display devices are applied mainly to amusement apparatuses, such as pachinko machines and slot machines, for use, so that the quality of the apparatuses can be improved. Such a display device is disclosed in the following Patent Document 1, for example.

(Patent Document 1) Japanese Unexamined Patent Publication 2005-46352

(Patent Document 2) Japanese Unexamined Patent Publication 2000-221282

### SUMMARY OF THE INVENTION

(Problem to Be Solved by the Invention)

In display devices formed as described above, however, there are signal lines which are physically divided into two sides of the non-display region in the above described window portion which is formed in part of the display region (non-display region).

In the case where scanning signals are supplied to the gate signal lines only from one end side of the substrate, the scanning signals can be supplied to the gate signal lines on one side of the above described window portion, but no scanning signals are supplied to the gate signal lines on the other side.

Likewise, in the case where video signals are supplied to the drain signal lines only from one end side of the substrate, the video signals can be supplied to the drain signal lines on one side of the above described window portion, but no video signals are supplied to the drain signal lines on the other side.

As a result, there is inevitably a portion which cannot display an image in within the display region in the display device, which is a disadvantage, because the range of application of the display device becomes narrow.

In the above described Patent Document 1, the electrical connection between respective divided signal lines is achieved by means of wires formed in pixel regions so that they bypass the surroundings of the hole corresponding to the above described window portion. In this configuration, however, there is inevitably a disadvantage, such that the configuration of the above described pixels becomes complicated, due to the wires.

An object of the present invention is to provide a display device which can display an image in any region within the display region without affecting the configuration of the pixels even with a non-display region.

Here, in the above described Patent Document 2, though there is a description of a hole through which an axis penetrates in a solar battery unit for a clock, and bypass signal lines in the vicinity of this hole, the above described hole is extremely small in diameter and there is only one bypass signal line formed in such a state as to be very close to a straight line. In addition, the object of the invention is not a display device.

(Means for Solving Problem)

The following is a summary of typical inventions from among the inventions disclosed in the present application.
(1) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of gate connection wires and a number of drain connection wires are formed so as to be aligned outside the above described display region,

a pair of gate signal lines which are divided into two sides of the above described non-display region by the above described non-display region are electrically connected by a corresponding gate connection wire, and

a pair of drain signal lines which are divided into two sides of the above described non-display region by the above described non-display region are electrically connected by a corresponding drain connection wire.
(2) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of gate connection wires are formed so as to be aligned outside the above described display region, and

a pair of gate signal lines which are divided into two sides of the above described non-display region by the above described non-display region are electrically connected by a corresponding gate connection wire.
(3) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of drain connection wires are formed so as to be aligned outside the above described display region, and

a pair of drain signal lines which are divided into two sides of the above described non-display region by the above described non-display region are electrically connected by a corresponding drain connection wire.
(4) The display device according to the present invention has, for example, the configuration of (1) or (2), and is characterized in that the above described gate signal lines are formed in a different layer from the above described drain signal lines via an insulating film, and the above described gate connection wires are formed in the same layer as the above described drain signal lines so that electrical connection with the above described gate signal lines can be achieved through through holes created in the above described insulating film.
(5) The display device according to the present invention has, for example, the configuration of (1) or (3), and is characterized in that the above described drain signal lines are formed in a different layer from the above described gate signal lines via an insulating film, and the above described drain connection wires are formed in the same layer as the above described gate signal lines so that electrical connection with the above described drain signal lines can be achieved through through holes created in the above described insulating film.
(6) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of bypass gate signal lines and a number of bypass drain signal lines are formed so as to be aligned within the above described display region and outside but close to the above described non-display region,

a pair of gate signal lines divided into two sides of the above described non-display region by the above described non-display region are electrically connected by a corresponding bypass gate signal line,

a pair of drain signal lines divided into two sides of the above described non-display region by the above described non-display region are electrically connected by a corresponding bypass drain signal line, and

at least the width or the pitch of the above described bypass gate signal lines is set smaller than the width or pitch of the above described gate signal lines and at least the width or the pitch of the above described bypass drain signal lines is set smaller than the width or pitch of the above described drain signal lines.
(7) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of bypass gate signal lines are formed so as to be aligned within the above described display region and outside but close to the above described non-display region,

a pair of gate signal lines divided into two sides of the above described non-display region by the above described non-display region are electrically connected by a corresponding bypass gate signal line, and

at least the width or the pitch of the above described bypass gate signal lines is set smaller than the width or pitch of the above described gate signal lines.
(8) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of bypass drain signal lines are formed so as to be aligned within the above described display region and outside but close to the above described non-display region,

a pair of drain signal lines divided into two sides of the above described non-display region by the above described non-display region are electrically connected by a corresponding bypass drain signal line, and

at least the width or the pitch of the above described bypass drain signal lines is set smaller than the width or pitch of the above described drain signal lines.
(9) The display device according to the present invention is, for example, a display device provided with a number of gate signal lines aligned on a first substrate in one direction and a number of drain signal lines aligned in such a direction as to cross the above described one direction with regions surrounded by these signal lines used as pixels, and characterized in that

a non-display region where none of gate signal lines, drain signal lines and pixels are formed is provided in part of a display region which is a group of the above described pixels,

a number of connection wires are formed so as to be aligned outside the above described display region, one of a pair of gate signal lines and a pair of drain signal lines which are divided into two sides of said non-display region by the above described non-display region are electrically connected to each other by a corresponding connection wire, and

a number of bypass signal lines are formed so as to be aligned within the above described display region and outside but close to the above described non-display region, the other one of a pair of gate signal lines and a pair of drain signal lines which are divided into two sides of the above described non-display region by the above described non-display region are electrically connected to each other by a corresponding bypass signal line.
(10) The display device according to the present invention has the same configuration as any of (1) to (9), and is characterized in that the above described display device is a liquid crystal display device having a second substrate which is arranged so as to face the above described first substrate through liquid crystal, and

the above described non-display region forms a window portion surrounded by a sealing material formed between the above described first substrate and the above described second substrate.
(11) The display device according to the present invention has the same configuration as any of (1) to (10), and is characterized in that the above described first substrate has an opening in a location corresponding to the above described non-display region.

Here, the present invention is not limited to having the above configuration, and various modifications are possible within such a scope as not to deviate from the technical idea of the present invention.

(Effects of the Invention)

In the display device having this configuration, an image can be displayed in any region within the display region without affecting the configuration of pixels, even when there is a non-display region.

### BRIEF DESCRIPTION OF THE DRAWINGS

FIG. 1 is a plan diagram showing the configuration of the display device according to one embodiment of the present invention, as well as gate signal lines and drain signal lines within the display region;

FIG. 2 is a plan diagram schematically showing a liquid crystal display device as an example of the display device according to one embodiment of the present invention;

FIG. 3 is a plan diagram showing one pixel from among pixels arranged in a matrix in the above described liquid crystal display device according to one embodiment;

FIG. 4 is a diagram showing the configuration of the display device according to another embodiment of the present invention, and corresponds to FIG. 1;

FIG. 5 is a diagram showing the configuration of the display device according to still another embodiment of the present invention, and corresponds to FIG. 1;

FIG. 6 is a diagram showing the configuration of the display device according to yet another embodiment of the present invention;

FIG. 7 is a diagram showing the configuration in FIG. 6, and shows only drain signal lines;

FIG. 8 is a diagram showing the configuration in FIG. 7, and shows drain signal lines and bypass drain signal lines having a different width and pitch;

FIG. 9 is a diagram showing the configuration in FIG. 6, and shows only gate signal lines; and

FIG. 10 is a diagram showing the configuration of the display device according to another embodiment of the present invention.

### EXPLANATION OF SYMBOLS

PNL . . . liquid crystal display panel
SUB1, SUB2 . . . substrates
SL1, SL2 . . . sealing material
SCN (V), SCN (H) . . . semiconductor devices
WD . . . window portion
AR . . . liquid crystal display region
GL . . . gate signal lines
DL . . . drain signal lines
TFT . . . thin film transistors
PX . . . pixel electrodes
CT . . . facing electrodes
GI . . . insulating film
PAS . . . protective film
TH1, TH2, TH2′, TH3, TH3′ . . . through holes
JGL . . . gate connection wires
JDL . . . drain connection wires
DGL . . . bypass gate signal lines
DDL . . . bypass drain signal lines

### DETAILED DESCRIPTION OF THE INVENTION

In the following, the display devices according to the embodiments of the present invention are described in reference to the drawings.

### First Embodiment

<Configuration of Entirety>

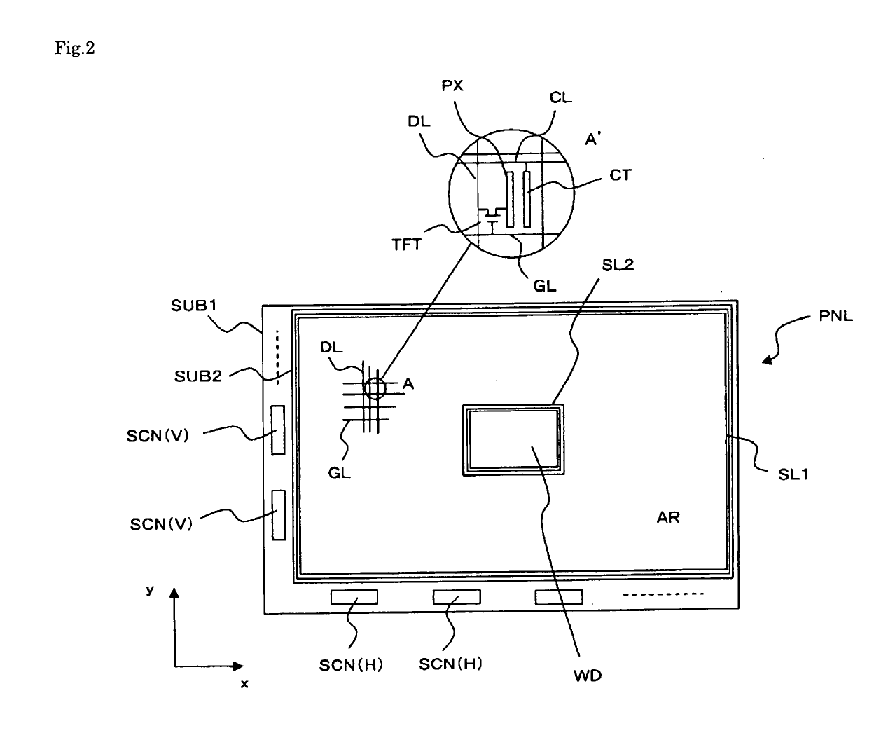

FIG. 2 shows a liquid crystal display device which is an example of the display device according to the present invention, and is a plan diagram schematically showing the liquid crystal display device according to one embodiment.

In FIG. 2, the liquid crystal display device has a pair of substrates SUB1 and SUB2 made of glass, for example, which are provided in such a manner as to face each other and are walls, and liquid crystal (not shown) is sandwiched between the substrates SUB1 and SUB2.

Here, the substrate SUB2 is secured to the substrate SUB1 by means of a sealing material SL1 which is applied around the periphery of the substrate SUB2 in annular form, and a sealing material SL2 which is applied within a region surrounded by the sealing material SL1, for example an annular pattern in the center portion.

The above described liquid crystal is sealed in the region between the sealing material SL1 and the sealing material SL2, and a liquid crystal display region AR is formed in this region.

Thus, the region surrounded by the sealing material SL2 is a region in which there is no liquid crystal, and a window portion (non-display region) WD is formed using the light transmitting properties of the substrates SUB1 and SUB2, so that the rear surface of the liquid crystal display device can be seen with the eye through this window portion WD. Here, in the window portion WD, holes are created in the above described substrate SUB1 and SUB2, so that a through hole (opening) having the above described sealing material SL2 as a side wall may be provided.

In addition, the area of the substrate SUB1 is greater than that of the substrate SUB2, and the substrate SUB1 has a region which is exposed from the above described SUB2 in the left side portion and lower side portion in the figure, for example. A number of semiconductor devices SCN (V) in chip form are mounted and aligned in the left side portion of the substrate SUB1 so as to form a scanning signal drive circuit, and a number of semiconductor devices SCN (H) in chip form are mounted and aligned in the lower side portion so as to form a video signal drive circuit.

Gate signal lines GL which extend in the x direction in the figure and are aligned in the y direction and drain signal lines which extend in the y direction in the figure and are aligned in the x direction are formed within the liquid crystal display region AR on the surface of the substrate SUB1 on the liquid crystal side.

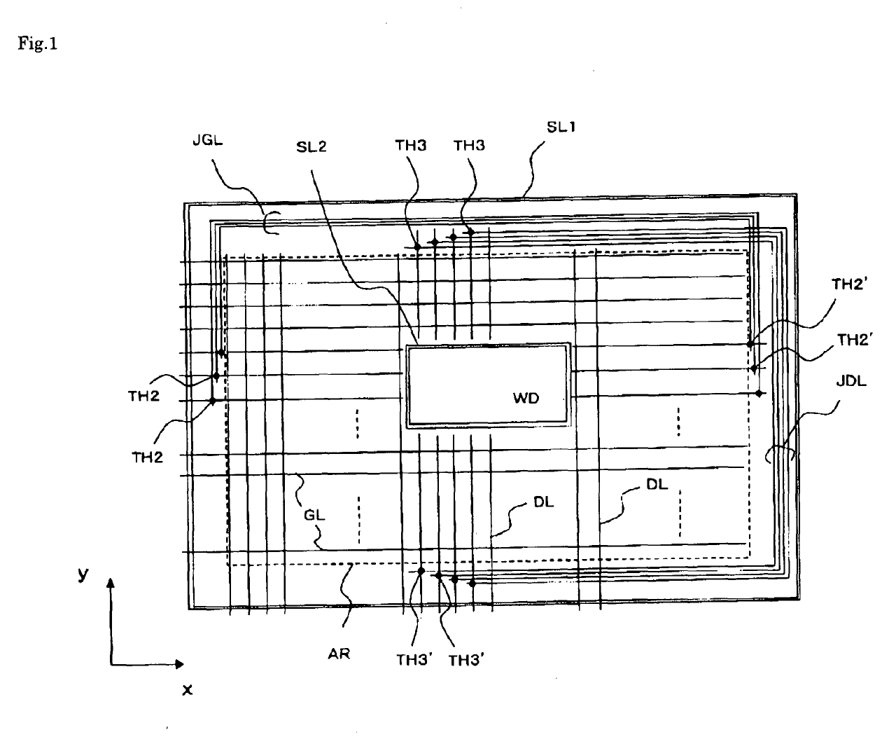

Here, no gate signal lines GL are formed in the above described window portion WD, but a pair of gate signal lines GL which are physically divided into the left and the right of the window portion WD in the figure by the window portion WD are provided. These divided gate signal lines GL are electrically connected to each other by a gate connection wire JGL, for example, which is formed inside the sealing material SL1 and outside the above described liquid crystal display region AR, as described in further detail below (FIG. 1).

In addition, no drain signal lines DL are formed in the above described window portion WD, but a pair of drain signal lines which are physically divided into the top and the bottom of the window portion WD in the figure by the window portion WD are provided. These divided drain signal lines DL are electrically connected by a drain connection wire JDL, for example, which is formed inside the sealing material SL and outside the above described liquid crystal display region AR in the configuration, as described in further detail below (FIG. 1).

Rectangular regions surrounded by the gate signal lines GL and the drain signal lines DL are regions where pixels are formed, and as a result, the pixels are arranged in a matrix the liquid crystal display region AR. Here, no pixels are formed in the window portion WD.

As shown in an enlargement A′ of the circled portion A in the figure, for example, each pixel is formed of a thin film transistor TFT which is turned on by a scanning signal from a gate signal line GL, a pixel electrode PX to which a video signal is supplied from a drain signal line DL via this thin film transistor TFT when turned on, and a facing electrode CT which is connected to a common signal line CL and to which a reference signal having a potential which can be used as a reference for the potential of the above described video signal is supplied.

Each of the above described gate signal lines GL extends over the sealing material SL1 at the left end, for example, so as to be connected to one output terminal of the corresponding semiconductor device SCN (V). In addition, each of the above described drain signal lines DL extends over the sealing material SL1 at the lower end so as to be connected to one output terminal of the corresponding semiconductor device SCN (H).

Here, in the above described liquid crystal display device, the above described scanning signal drive circuit and the video signal driving circuit are formed of semiconductor devices made of a semiconductor chip mounted on the surface of the substrate SUB1. However, one side of semiconductor devices formed in a tape carrier system or a COF (chip on film) system, for example, may be connected to the substrate SUB1. In addition, a circuit may be integrally created on the substrate SUB1.

<Configuration of Pixels>

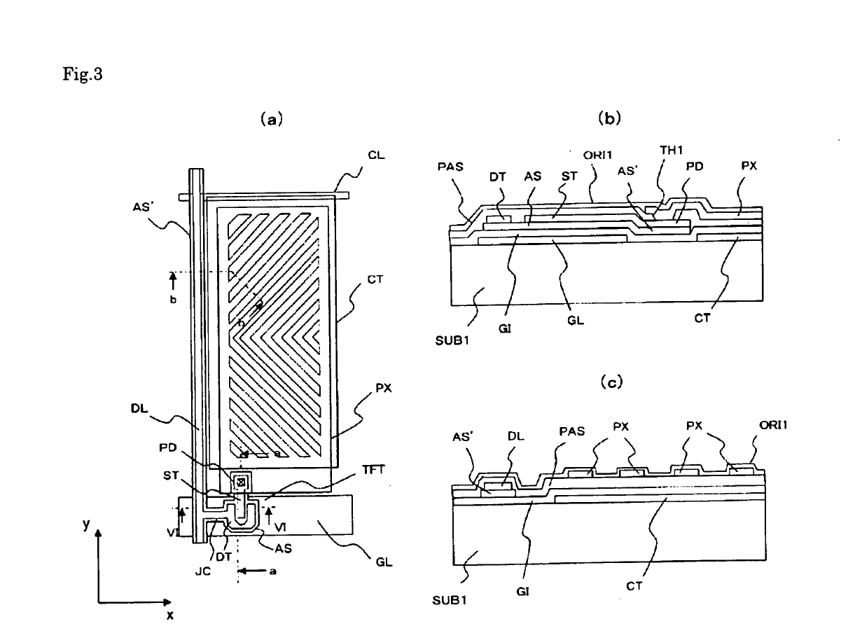

FIG. 3(a) is a plan diagram showing one pixel from among the pixels arranged in a matrix on the substrate SUB1 side of the above described liquid crystal display device according to one embodiment.

In addition, FIGS. 3(b) and 3(c) respectively show a cross sectional diagram along line a-a in FIG. 3(a) and a cross sectional diagram along line b-b in FIG. 3(a).

First, gate signal lines GL and common signal lines CL are formed in parallel at a relatively large distance from each other on the surface (front surface) on the liquid crystal side of the substrate SUB1.

In the region between the gate signal lines GL and the common signal lines CL, facing electrodes CT are formed of a transparent conductive material, such as ITO (indium-tin-oxide). The facing electrodes CT are formed so that the side portion on the common signal line CL side overlaps with the common signal lines CL, and thus, the facing electrodes CT are formed so as to be electrically connected to the common signal lines CL.

In addition, an insulating film GI (see FIG. 3) is formed on the surface of the substrate SUB1 so as to cover the above described gate signal lines GL, common signal lines CL and facing electrodes CT. This insulating film GI functions as a gate insulating film for the below described thin film transistors TFT in the regions where thin film transistors TFT are formed, and the film thickness and the like are set accordingly.

An amorphous semiconductor layer AS is formed from, for example, amorphous silicon, in portions on the upper surface of the above described insulating film GI which overlap with part of the above described gate signal lines GL. This semiconductor layer AS becomes a semiconductor layer for the above described thin film transistors TFT.

Here, as shown by AS′, the semiconductor layer AS is formed as a layer beneath the drain signal lines DL, a layer beneath the connection portions JC for electrically connecting the drain signal lines DL and the drain electrodes BT of the thin film transistors TFT, and as a layer beneath portions of the source electrodes ST of the thin film transistors TFT which extend over the region where thin film transistors TFT are formed (including pad portions PD), for example, in addition to the regions where thin film transistors TFT are formed, and thus, only small steps can be formed in the drain signal lines DL, for example.

In addition, drain signal lines DL are formed so as to extend in the y direction in the figure, these drain signal lines DL have an extension portion which extends from a portion of the drain signal lines toward the above described thin film transistor TFT, and this extension portion (connection portion JC) is connected to the drain electrode DT of the thin film transistor TFT formed above the above described semiconductor layer AS.

In addition, source electrodes ST which are simultaneously formed when the drain signal lines DL and the drain electrodes DT are formed face the above described drain electrodes DT above the above described semiconductor layer AS, and have an extension portion which extends from the semiconductor layer AS toward the pixel region, which is not far away. This extension portion is formed so as to reach a pad portion PD which is connected to the below described pixel electrode PX.

The above described drain electrodes DT are formed in U shape, for example, and surround the front end portion of the above described source electrode ST. As a result, the channel width of the thin film transistors TFT can be increased in the configuration.

Here, when the above described semiconductor layer AS is formed on the insulating film GI, the surface of the semiconductor layer AS is doped with an impurity of a high concentration, and after the formation of the above described drain electrodes DT and source electrodes ST through patterning, for example, the impurity layer of a high concentration formed in regions other than the regions where drain electrodes DT and source electrodes ST are formed are etched away using a photoresist film on the drain electrodes DT and the source electrodes ST as a mask. The impurity layer of a high concentration remains between the semiconductor layer AS and the drain electrodes DT, as well as between the semiconductor layer AS and the source electrodes ST, and this impurity layer is formed as an ohmic contact layer.

Thus, the above described thin film transistors TFT having an MIS (metal insulator semiconductor) structure are formed as transistors having a so-called reverse stagger structure using a gate signal line GL as a gate electrode.

Here, though transistors having an MIS structure are driven so that the drain electrode DT and the source electrode ST are switched due to application of a bias, in the description in this specification, that connected to the drain signal line DL is referred to as drain electrode DT, and that connected to the pixel electrode PX is referred to as source electrode ST for the sake of convenience.

A protective film PAS made of an insulating film is formed so as to cover the above described thin film transistors TFT on the surface of the substrate SUB. This protective film PAS is provided in order to prevent the thin film transistors TFT from making direct contact with the liquid crystal. In addition, this protective film PAS intervenes between the above described facing electrodes CT and the below described pixel electrodes PX, and functions as a dielectric film for capacitive elements provided between the facing electrodes CT and the pixel electrodes PX, together with the above described insulating film GI.

Pixel electrodes PX are formed on the upper surface of the above described protective film PAS. These pixel electrodes PX are formed of a transparent conductive film, such as of ITO (indium-tin-oxide) so as to overlap with the above decried facing electrodes CT over a large area.

In addition, a great number of slits are created side by side in such a direction as to cross the longitudinal direction in the pixel electrodes PX which, as a result, are formed so as to have an electrode group made of a great number of electrodes in line form with the two ends connected to each other.

Here, as shown in FIG. 1, each electrode in the pixel electrodes PX is formed so as to extend in the direction +45° relative to the direction in which the gate signal lines GL run in one of two regions in a pixel which is divided into upper and lower portions in the figure, for example, and extend in the direction −45° in the other region. The configuration adopts a so-called multi-domain system, which gets rid of the inconvenience of coloring which may occur depending on the direction from which the screen is viewed in the case where the direction of the slits provided in the pixel electrode within each pixel (direction of electrode group in the pixel electrode PX) is single.

The thus formed pixel electrodes PX are electrically connected to the pad portion PD of the source electrodes ST in the thin film transistors TFT in the side portion on the thin film transistor TFT side through through holes TH1 created in the above described protective film PAS. In addition, an orientation film ORI1 is formed on the surface of the substrate SUB1 so as to cover the pixel electrodes PX.

<Gate Connection Wires, Drain Connection Wires>

FIG. 1 is a plan diagram showing only gate signal lines GL, drain signal lines DL, gate connection wires JGL and drain connection wires JDL in the region surrounded by a sealing material SL1 and a sealing material SL2 in the above described liquid crystal display device.

The gate signal lines GL are formed in the region within the sealing material SL1 so as to extend in the x direction in the figure and be aligned in the y direction, but not in the above described window portion WD surrounded by the sealing material SL2, and pairs of gate signal lines GL located on the left and right of the window portion WD in the figure are physically divided by the window portion WD.

In addition, in the region inside the sealing material SL1 and outside the liquid crystal display region AR (hereinafter in some cases referred to as display periphery region), gate connection wires JGL for making electrical connection between the gate signal lines GL on the left of the above described window portion WD and the gate signal lines GL on the right in the figure are formed.

Here, the above described liquid crystal display region AR is a region where pixels are arranged in a matrix. That is to say, the above described gate connection wires JGL and drain connection wires JDL are formed in a region where no pixels are formed.

That is to say, a number of gate connection wires JGL are formed in the display periphery region on the upper side in the figure so as to extend in the x direction and be aligned in the y direction in the figure. At least the same number of gate connection wires JGL is formed as gate signal lines GL which are divided by the above described window portion WD.

These gate signal wires JGL are formed in the same layer as the above described drain signal lines DL, though this is not clear from FIG. 1, and formed of the same material as the drain signal lines DL.

The gate connection wires JGL are bent on the left end side in the figure, and extend in the y direction in the figure in the display periphery region on the left in the figure so as to be connected to the gate signal lines GL on one side, which are divided in the portion where the gate connection wires extend through through holes TH2 created in the insulating film GI (see FIG. 3). In addition, the gate connection wires JGL are bent on the right end side in the figure, and extend in the y direction in the figure in the display periphery region on the right in the figure so as to be connected to the gate signal lines GL on the other side, which are divided in the portion where the gate connection wires extend through through holes TH2′ created in the above described insulating film GI.

Likewise, the drain signal lines DL are also formed in the region within the sealing material SL I so as to extend in the y direction in the figure and be aligned in the x direction, but not in the above described window portion WD surrounded by the sealing material SL2, and pairs of drain signal lines DL located on the top and bottom of the window portion WD in the figure are physically divided by the window portion WD.

In addition, drain connection wires JDL for making electrical connection between the drain signal lines DL on the upper side in the figure and the drain signal lines DL on the lower side in the figure are formed in the display periphery region.

That is to say, in the display periphery region on the right in the figure, a number of drain connection wires JDL are formed so as to extend in the y direction in the figure and be aligned in the x direction. At least the same number of drain connection wires JDL is formed as drain signal lines DL divided by the above described window portion WD.

These drain signal wires JDL are formed in the same layer as the above described gate signal lines GL, and formed of the same material as the gate signal lines GL.

The drain connection wires JDL are bent on the upper end side in the figure, and extend in the x direction in the figure in the display periphery region on the upper side in the figure so as to be connected to the drain signal lines DL on one side, which are divided in the portion where the drain connection wires extend through through holes TH3 created in the insulating film GI. In addition, the drain connection wires JDL are bent on the lower end side in the figure, and extend in the x direction in the figure in the display periphery region on the lower side in the figure so as to be connected to the drain signal lines DL on the other side, which are divided in the portion where the drain connection wires extend through through holes TH3′ created in the above described insulating film GI.

The thus formed liquid crystal display device can supply a scanning signal to all pixels in the liquid crystal display region AR via gate signal lines GL and a video signal via drain signal lines DL, and as a result display an image in the liquid crystal display region AR.

Though in FIG. 1, gate connection wires JGL and drain connection wires JDL which run in the same direction are arranged so as not to overlap in order not to make the drawing complicated, they are formed in different layer, and therefore, they may be arranged so as to partially overlap. In this case, the area of the display periphery region can be reduced.

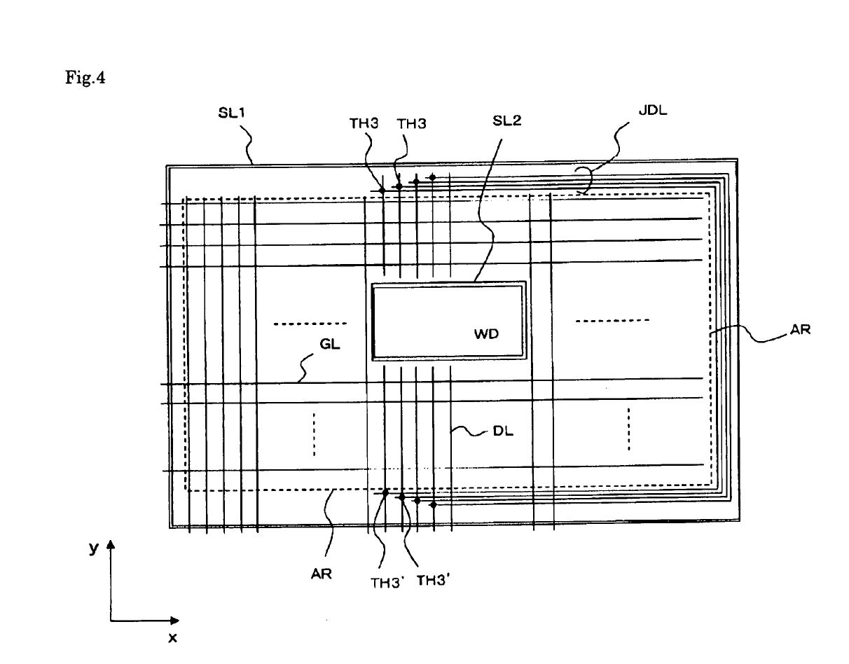

FIG. 4 is a diagram showing the configuration of the display device according to another embodiment of the present invention, and corresponds to FIG. 1.

The configuration is different from that in FIG. 1 in that the drain signal lines DL on the upper side of the above described window portion WD in the figure and the drain signal lines DL on the lower side in the figure are only electrically connected via the drain connection wires JDL, and the gate signal lines GL on the left side in the figure and the gate signal lines GL on the right side in the figure are not electrically connected over the above describe window portion WD.

In this case, no image is displayed in the region on the right side of the window portion WD in the figure within the liquid crystal display region AR, that is to say, in the region having gate signal lines GL which are not connected to the scan signal drive circuit (semiconductor device SCN (V)), but effects can be gained, such that an image can be displayed in regions on the upper side of the window portion WD in the figure and on the left side.

Therefore, the present embodiment can be applied in the case where a liquid crystal display device is desired to be used in such a display mode.

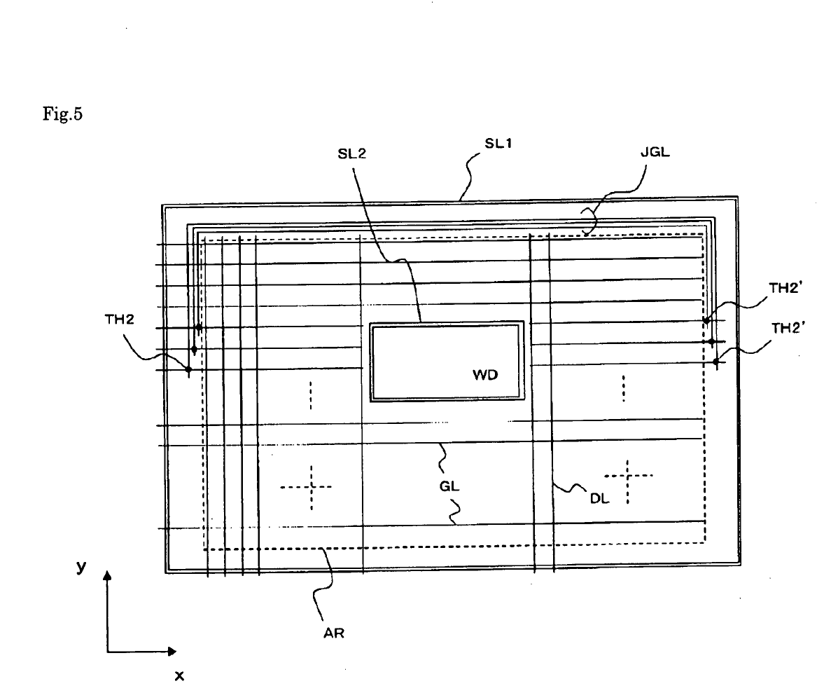

Likewise, FIG. 5 is a diagram showing the configuration of the display device according to another embodiment of the present invention, and corresponds to FIG. 1.

The configuration is different is different from that in FIG. 1 in that the gate signal lines GL on the left side of the above described window portion WD in the figure and the gate signal lines GL on the right side in the figure are only electrically connected via the gate connection wires JGL, and the drain signal lines DL on the upper side in the figure and the drain signal lines DL on the lower side in the figure are not electrically connected over the above describe window portion WD.

In this case, no image is displayed in the region on the upper side of the window portion WD in the figure within the liquid crystal display region AR, that is to say, in the region having drain signal lines DL which are not connected to the video signal drive circuit (semiconductor device SCN (H)), but effects can be gained, such that an image can be displayed in regions on the right side of the window portion WD in the figure and on the lower side.

Therefore, the present embodiment can be applied in the case where a liquid crystal display device is desired to be used in such a display mode.

### Second Embodiment

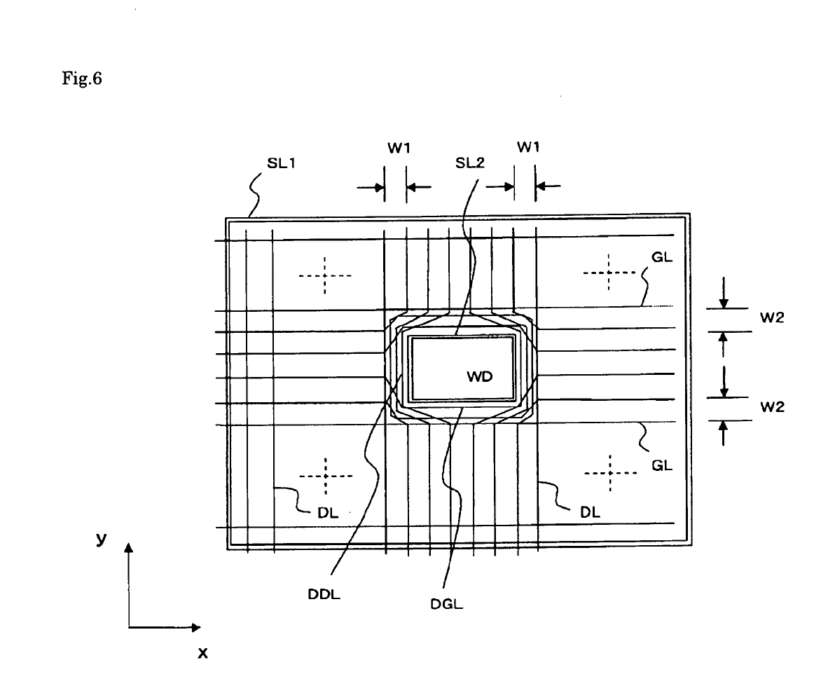

FIG. 6 is a diagram showing the configuration of the display device according to another embodiment of the present invention, and a plan diagram showing only the gate signal lines GL and the drain signal lines DL in the region surrounded by the sealing material SL1 and the sealing material SL2.

Pairs of gate signal lines GL which are divided by the window portion WD from among the gate signal lines GL which extend in the x direction in the figure and are aligned in the y direction are respectively connected via a number of bypass gate signal lines DGL which extend in the x direction in the figure and are aligned in the y direction in respective peripheral regions having a width W1 on the upper and lower side of the sealing material SL2 which surrounds the window portion WD. Here, no pixels are formed in the above described peripheral regions.

The bypass gate signal lines DGL are formed in the same layer as the gate signal lines GL, for example, and at the same time as the gate signal lines GL.

In addition, pairs of gate signal lines GL placed on the top in the figure from among the pairs of gate signal lines GL which are divided by the window portion WD are connected to the respective bypass gate signal lines DGL which are located in a peripheral region above the above described window portion WD in the figure, while pairs of gate signal lines GL located at the bottom in the figure are connected to the respective bypass gate signal lines located in the peripheral region beneath the above described window portion WD in the figure. As a result, the width WI of the above described peripheral regions can be reduced. Here, no pixels are formed in the above described peripheral regions.

In addition, pairs of drain signal lines DL divided by the window portion WD from among the drain signal lines DL which extend in the y direction in the figure and are aligned in the x direction are respectively connected via a number of bypass drain signal lines DDL which extend in the y direction in the figure and are aligned in the x direction in the respective peripheral regions having a width W2 on the left and right side of the sealing material SL2 surrounding the window portion WD.

The bypass drain signal lines DDL are formed in the same layer as the drain signal lines DL, for example, and at the same time as the drain signal lines DL.

In addition, pairs of drain signal lines DL located on the left side in the figure from among the pairs of drain signal lines DL which are divided window portion WD are connected to the respective bypass drain signal lines DDL, which are arranged in the peripheral region on the left side of the above described window portion WD in the figure, while pairs of drain signal lines DL located on the right side in the figure are connected to the respective bypass drain signal lines DDL located in the peripheral region on the right side of the above described window portion WD in the figure. As a result, the width W2 of the above described peripheral regions can be reduced.

In the thus formed liquid crystal display device, a scan signal can be supplied to all pixels in the portion within the region surrounded by the sealing material SL 1 excluding the window portion WD and its peripheral region (width W1 and W2) via the gate signal lines GL, and a video signal can be supplied via the drain signal lines DL, and as a result, an image can be displayed in the liquid crystal display region AR.

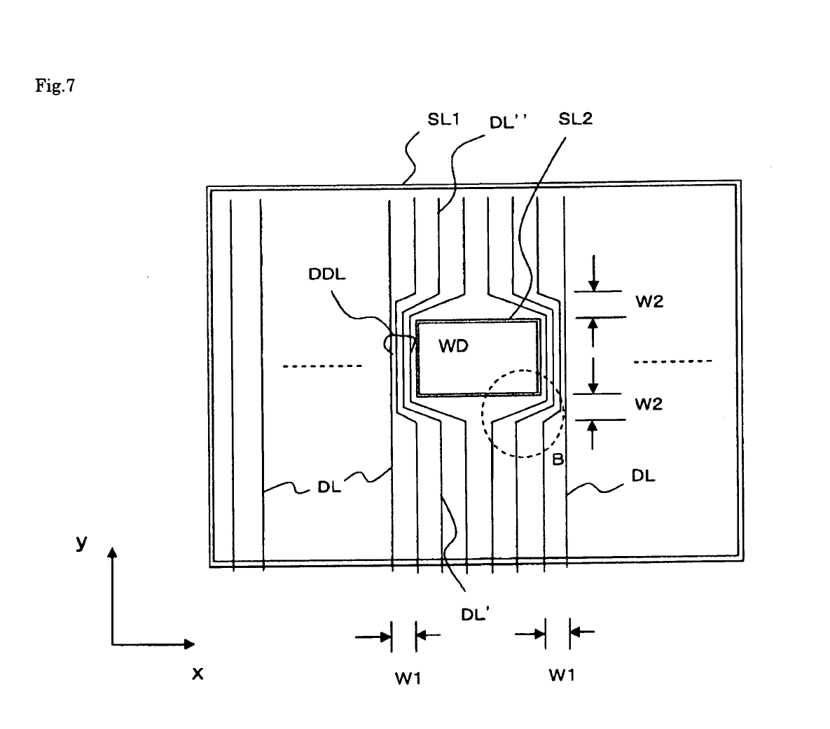

FIG. 7 is similar to FIG. 6 but clearly shows the state where drain signal lines DL are aligned with the gate signal lines GL removed.

As shown in FIG. 7, the respective drain signal lines DL located in the window portion WD and the peripheral region thereof in such a manner as to cross the window portion (shown by symbol DL′, for example, in figure) bend in front portions of the window portion DW having a length W2 so as to bypass the window portion WD on either side (bypass drain signal lines DDL), and after bending back, lead to the drain signal lines DL having starting points at a distance W2 from the above described window portion DW and located along the same straight lines as the above described drain signal lines DL′ (shown by symbol DL″, for example, in figure) in the configuration. In addition, the bypass drain signal lines DDL are contained within the width W1.

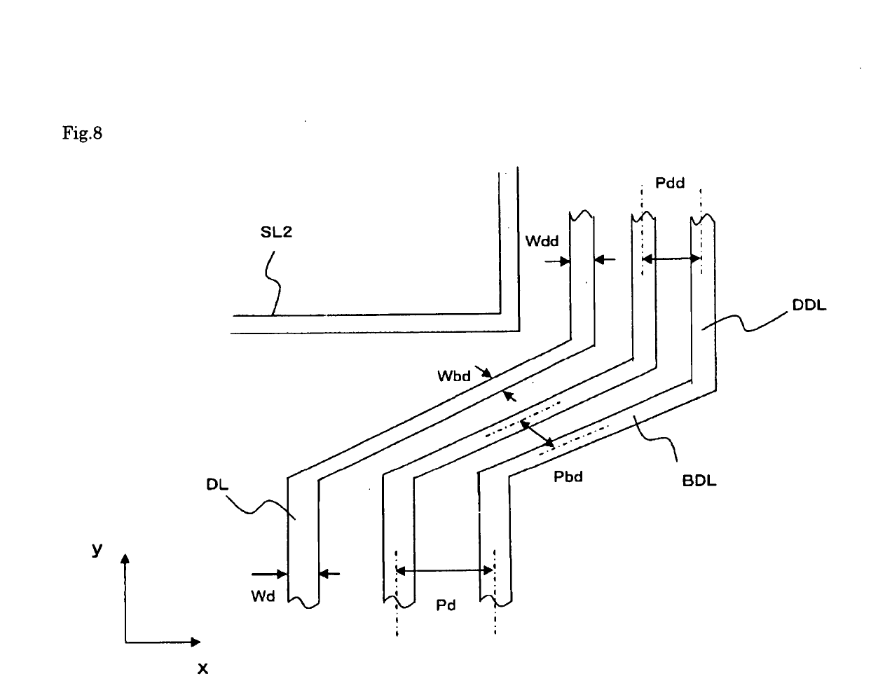

Here, FIG. 8 is a diagram showing an enlargement of the dotted circle B in FIG. 7. FIG. 8 clarifies the relationship between the respective widths and pitches of the drain signal lines DL, the bypass drain signal lines DDL and the signal lines formed so as to bend from the above described drain signal lines DL to the bypass drain signal lines DDL (hereinafter referred to as bending drain signal lines DDL for the sake of convenience).

The drain signal lines DL are formed so as to have a width Wd, and the distance from the other adjacent drain signal lines DL is set to Pd. In addition, the bypass drain signal lines DDL are formed so as to have a width Wdd, and the distance from the other adjacent bypass drain signal lines DDL is set to Pdd.

In FIG. 8, the width Wd of the drain signal lines DL, the width Wbd of the bending drain signal lines BDL and the width Wdd of the bypass drain signal lines DDL are set different from each other, and the relationship is such that Wd>Wdd>Wbd.

Likewise, the pitch Pd of the respective drain signal lines DL, the pitch Pbd of the respective bending drain signal lines BDL and the pitch Pdd of the respective bypass drain signal lines DDL are set different from each other, and the relationship is such that Pd>Pdd>Pbd.

The reason why the width and the pitch of the drain signal lines DL, the bypass drain signal lines DDL and the bending drain signal lines BDL are set as such is that the bypass drain signal lines DDL can be arranged within the peripheral region outside the window portion WD, so that the width W1 and W2 thereof can be made as small as possible. Therefore, the minimum requirement in the above described setting is that the width Wdd of the bypass drain signal lines DDL be set smaller than the width Wd of the drain signal lines DL and the pitch Pdd of the bypass drain signal lines be set smaller than the pitch Pd of the drain signal lines DL.

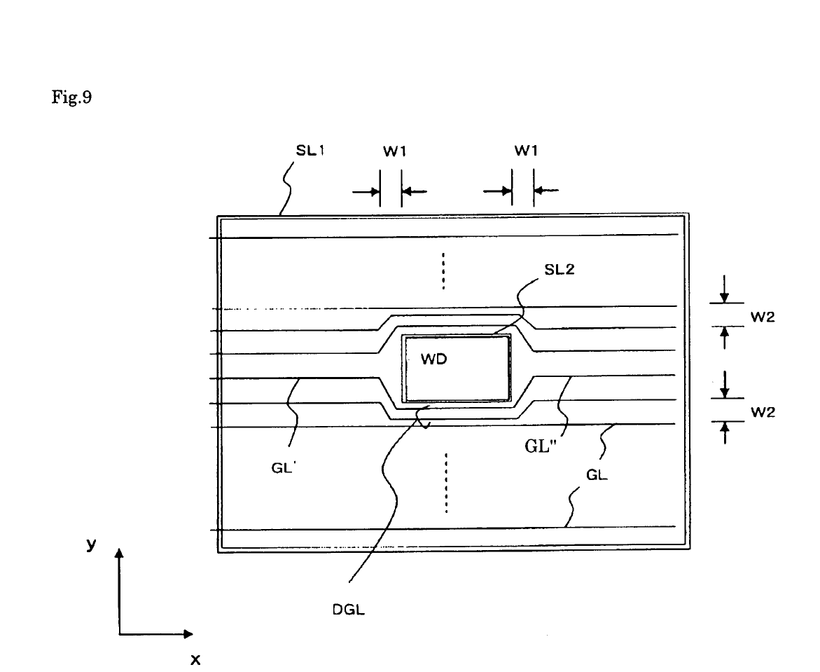

FIG. 9 is similar to FIG. 6 but clearly shows the state where gate signal lines GL are aligned with the drain signal lines DL removed.

As shown in FIG. 9, the respective gate signal lines GL which are arranged so as to cross the window portion WD and the peripheral region thereof (shown by symbol GL′, for example, in figure) bend in a portion before the window portion WD having a length W2, for example and bypass the above described window portion WD on either side (bypass gate signal lines DGL), and after bending back, lead to the gate signal lines GL (shown by symbol GL″, for example, in figure) having starting points at a distance W1 from the above described window portion DW, and aligned along the same straight lines as the above described gate signal lines GL′ in the configuration.

Here, the relationship between the width and pitch of respective gate signal lines GL, bypass gate signal lines DGL and signal lines which bend from the above described gate signal lines GL to the bypass gate signal lines DGL are the same as the relationship shown in FIG. 8.

In the embodiment shown in FIG. 6, the gate signal lines GL and the drain signal lines DL respectively bypass the window portion WD in the periphery in the configuration. However, the invention is not limited to this, and only the gate signal lines GL may bypass the window portion WE in the periphery, or only the drain signal lines DL may bypass the window portion WD in the periphery.

### Third Embodiment

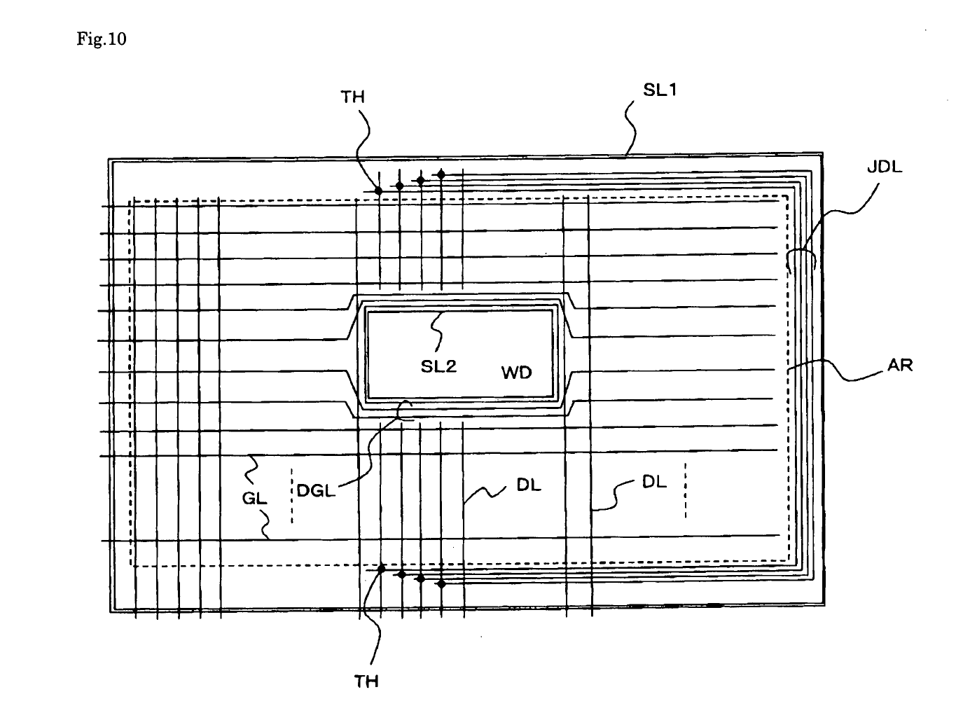

FIG. 10 is a diagram showing the configuration of the display device according to another embodiment of the present invention, and corresponds to FIG. 1.

In FIG. 10, pairs of drain signal lines DL which are provided so as to cross the window portion WD are physically divided by the window portion WD, and these corresponding drain signal lines DL are electrically connected by a drain connection wire JDL provided in the display periphery region.

In addition, pairs of gate signal lines GL which are provided so as to cross the window portion WD and the peripheral region thereof are electrically connected via bypass gate signal lines DGL which are provided on the two sides of the window portion WD.

Even in this case, all of the pixels in the liquid crystal display region AR can be supplied with a scanning signal via the gate signal lines, and with a video signal via the drain signal lines in the configuration, and thus, an image can be displayed in the liquid crystal display region AR.

In addition, the gate signal lines GL may be electrically connected using the gate connection wires JGL and the drain signal lines DL may be electrically connected using the bypass drain signal lines DDL, and in this case also, the same effect as in the configuration shown in FIG. 10 can be gained.

In the above described embodiments, a liquid crystal display device where a window portion WD is created in part of the liquid crystal display region AR, which is a group of pixels, is cited as an example. However, the invention is not necessarily limited to display devices where a window portion WD is created, and the present invention can, of course, be applied in a non-display region where no gate signal lines GL, drain signal lines DL or pixels are formed.

The respective embodiments are described above citing a liquid crystal display device as an example. However, the present invention can, of course, be applied to other display devices, for example organic EL display devices.

The above described embodiments may be used alone or combined for use. This is because the effects in the respective embodiments can be gained alone or in combination.

1. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of gate connection wires and a number of drain connection wires are formed so as to be aligned outside said display region,
a pair of gate signal lines which are divided into two sides of said non-display region by said non-display region are electrically connected by a corresponding gate connection wire, and
a pair of drain signal lines which are divided into two sides of said non-display region by said non-display region are electrically connected by a corresponding drain connection wire.

2. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of gate connection wires are formed so as to be aligned outside said display region, and
a pair of gate signal lines which are divided into two sides of said non-display region by said non-display region are electrically connected by a corresponding gate connection wire.

3. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of drain connection wires are formed so as to be aligned outside said display region, and
a pair of drain signal lines which are divided into two sides of said non-display region by said non-display region are electrically connected by a corresponding drain connection wire.

4. The display device according to claim 1, characterized in that said gate signal lines are formed in a different layer from said drain signal lines via an insulating film, and said gate connection wires are formed in the same layer as said drain signal lines so that electrical connection with said gate signal lines can be achieved through through holes created in said insulating film.

5. The display device according to claim 1, characterized in that said drain signal lines are formed in a different layer from said gate signal lines via an insulating film, and said drain connection wires are formed in the same layer as said gate signal lines so that electrical connection with said drain signal lines can be achieved through through holes created in said insulating film.

6. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of bypass gate signal lines and a number of bypass drain signal lines are formed so as to be aligned within said display region and outside but close to said non-display region,
a pair of gate signal lines divided into two sides of said non-display region by said non-display region are electrically connected by a corresponding bypass gate signal line,
a pair of drain signal lines divided into two sides of said non-display region by said non-display region are electrically connected by a corresponding bypass drain signal line, and
at least the width or the pitch of said bypass gate signal lines is set smaller than the width or pitch of said gate signal lines and at least the width or the pitch of said bypass drain signal lines is set smaller than the width or pitch of said drain signal lines.

7. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of bypass gate signal lines are formed so as to be aligned within said display region and outside but close to said non-display region,
a pair of gate signal lines divided into two sides of said non-display region by said non-display region are electrically connected by a corresponding bypass gate signal line, and
at least the width or the pitch of said bypass gate signal lines is set smaller than the width or pitch of said gate signal lines.

8. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of bypass drain signal lines are formed so as to be aligned within said display region and outside but close to said non-display region,
a pair of drain signal lines divided into two sides of said non-display region by said non-display region are electrically connected by a corresponding bypass drain signal line, and
at least the width or the pitch of said bypass drain signal lines is set smaller than the width or pitch of said drain signal lines.

9. A display device, comprising a number of gate signal lines aligned on a first substrate in one direction and a number of drain signal lines aligned in such a direction as to cross said one direction with regions surrounded by these signal lines used as pixels, characterized in that
a non-display region where none of gate signal lines, drain signal lines and pixels are formed is provided in part of a display region which is a group of said pixels,
a number of connection wires are formed so as to be aligned outside the above described display region, one of a pair of gate signal lines and a pair of drain signal lines which are divided into two sides of said non-display region by the above described non-display region are electrically connected to each other by a corresponding connection wire, and
a number of bypass signal lines are formed so as to be aligned within the above described display region and outside but close to the above described non-display region, the other one of a pair of gate signal lines and a pair of drain signal lines which are divided into two sides of the above described non-display region by the above described non-display region are electrically connected to each other by a corresponding bypass signal line.

10. The display device according to claim 1, characterized in that
said display device is a liquid crystal display device having a second substrate which is arranged so as to face said first substrate through liquid crystal, and
said non-display region forms a window portion surrounded by a sealing material formed between said first substrate and said second substrate.

11. The display device according to claim 1, characterized in that said first substrate has an opening in a location corresponding to said non-display region.
